(19) United States
(12) Patent Application Publication
(10) Pub. No.: US 2017/0050506 A1
(43) Pub. Date: Feb. 23, 2017

(54) TORQUE TRANSMISSION DEVICE FOR A HYBRID VEHICLE

(71) Applicant: Schaeffler Technologies AG & Co. KG, Herzogenaurach (DE)

(72) Inventors: Andreas Trinkenschuh, Buhl (DE); Willi Ruder, Lahr (DE); Florian Nachtmann, Strassburg (FR); Dominque Engelmann, Offendorf (FR)

(73) Assignee: Schaeffler Technologies AG & Co. KG, Herzogenaurach (DE)

(21) Appl. No.: 15/306,881

(22) PCT Filed: May 5, 2015
(86) PCT No.: PCT/DE2015/200296

§ 371 Date: Oct. 26, 2016

(30) Foreign Application Priority Data
May 16, 2014 (DE) 10 2014 209 356.2

(51) Int. Cl. B60K 6/387; H02K 7/02; F16D 3/12; H02K 7/10; B60K 6/26; F16D 13/52

(52) U.S. Cl. CPC B60K 6/387; B60K 6/26; F16D 13/52; F16D 3/12; H02K 7/10; H02K 7/02; Y10S 903/914; Y10S 903/906; F16D 2300/22; F16D 25/0638

(57) ABSTRACT

The invention relates to a torque transmission device that is to be arranged in a drive train of a hybrid vehicle having an internal combustion engine, a transmission and an electric machine, the electric machine being arranged in the torque transmission device. The torque transmission device includes a disconnect clutch with clutch actuation, for decoupling the internal combustion engine from the transmission, and a primary torsional vibration damper on the crankshaft side. The invention has a secondary torsional vibration damper arranged on the transmission side, radially and axially inside the rotor and directly on the transmission-side output flange of the torque transmission device. This allows the installation space for the crankshaft-side primary torsional vibration damper to be increased, such that the damper can be optimally designed. In torque transmission devices which originally have no secondary damper, the design of the primary damper can be smaller and more compact since the secondary damper supports the vibration damping. Since the secondary damper is arranged inside the rotor of the electric machine and directly on the transmission-side output flange of the torque transmission device, this damper requires only minimal or no additional installation space. This leaves surplus installation space which can be used, for example, to reduce the size of the torque transmission device, in particular to axially shorten it, or be used to increase the size of the electric machine.

### BACKGROUND

The invention relates to a torque transmission device to be arranged in a drivetrain of a hybrid vehicle.

Generic torque transmission devices are common in the automotive field in many cases or required for a controlled and perhaps detachable transmitting of force between the internal combustion engine, the electric machine, and the transmission. For this purpose, a generic torque transmission device assumes on the one side the function of transmitting torque from the internal combustion engine and/or from the electric machine to a driveshaft and/or a transmission, and on the other side the function of damping torsional vibrations between the internal combustion engine, the transmission, and/or the electric machine.

The torque transmission device can additionally be embodied for starting the internal combustion engine. Usually here the electric machine is integrated in the torque transmission device, which allows the frequently demanded space-saving design, particularly in the axial direction.

Usually, generic torque transmission devices show a disconnect clutch, by which the force flux between the internal combustion engine and the transmission and/or the electric machine can be connected or disconnected depending on the operating situation, for example when the vehicle is stationary or during the purely electric drive and/or thrust operation. Sometimes, the internal combustion engine is also started by the electric machine via a disconnect clutch being connected for this purpose. In other embodiments the engine is started with a disconnected clutch and the disconnect clutch is only connected when the speed of the engine and the speed of the transmission are equivalent.

In order to isolate the torsional vibrations and/or dampen the torsional vibrations here one or more centrifugal masses and/or rotary vibration dampers may be provided in or at the torque transmission device, e.g., in the form of a bow spring damper or a centrifugal pendulum, or in the form of a combination thereof.

Overall, in addition to control the force flux, a generic torque transmission device therefore assumes important tasks in the field of isolating the torsional vibration, which is important for acoustic comfort, the useful life of the transmission, and low fuel consumption. A good isolation of torsional vibration also allows at low speeds a non-slip and low-noise transmitting of torque between the internal combustion engine and the transmission, particularly in case of automatic transmissions, such as duplex clutch transmissions, continuously variable transmissions, or stepped automatic transmissions of hybrid vehicles.

The plurality of functions and components involved here leads to the fact that generic torque transmission devices usually require considerable structural space, particularly in the axial direction.

Torque transmission devices with primary dampers at the side of the crankshaft are known, for example comprising bow spring dampers, with here for an improved damping of torsional vibrations particularly at low engine speeds a centrifugal pendulum being integrated as a secondary damper inside the primary damper and/or arranged in the direct proximity of the primary damper, in case of a bow spring damper preferably at the secondary side of the bow spring damper already partially damping vibrations. In this arrangement a centrifugal pendulum is particularly effective, which with regards to vibrations represents a vibration absorber switched parallel in reference to the rotating masses of the torque transmission device. An absorber, for example a centrifugal pendulum, is advantageous among other things in that the elasticity of the drivetrain is not compromised thereby so that any direct influencing is avoided, particularly of the agility of the vehicle.

However, torque transmission devices embodied in this fashion show relatively high inertia, and the structural space required by the primary damper together with the secondary damper and/or absorber arranged in the immediate proximity of the primary damper is relatively large, here. This can in turn lead to the necessity to use a primary damper which is not optimally sized and/or too small, rendering it hard or impossible to achieve the desired isolation with regards to vibrations.

Such limitations with regards to the structural space available for the primary damper can also be caused by framework conditions for the installation as stipulated by the customer and/or caused by the given electric machine exhibiting a relatively large axial structural space.

### SUMMARY

In light of this information the objective of the present invention is to provide a torque transmission device by which the problems shown at the outset can be addressed with regards to the demands of customers, limited structural space, and desired optimal damping of torsional vibrations, while simultaneously providing a simple and robust design of the torque transmission device.

This objective is attained in a torque transmission device with one or more features of the invention. The torque transmission device according to the present invention serves here in a manner known per se for an arrangement in a drivetrain particularly of a hybrid vehicle comprising an internal combustion engine and a transmission, as well as an electric drive in the form of an electric machine integrated in the torque transmission device. The electric machine comprises a rotor, which can rotate about a central longitudinal axis of the torque transmission device, while the torque transmission device comprises a disconnect clutch with a clutch actuation for disconnecting the internal combustion engine from the transmission, as well as a torsional vibration damper (hereinafter called primary damper) at the side of the crankshaft.

According to the invention the torque transmission device is characterized in that radially and axially inside the rotor of the electric machine a torsional vibration damper is arranged at the transmission side (hereinafter called secondary damper), which is arranged directly in the output flange of the torque transmission device at the transmission side.

“Directly at the output flange at the transmission side” shall here be understood in the sense of the invention that the secondary damper (initially regardless if it represents for example a serial torsional vibration damper or a parallel absorber) is arranged in the immediate proximity of the output flange at the transmission side and directly connected to the output flange at the transmission side, and/or (particularly for receiving e.g., a serial torsional vibration damper) forms a joint assembly together with the output flange at the transmission side.

The arrangement of a secondary damper inside the rotor of the electric machine as well as immediately in the output flange at the transmission side is advantageous in several aspects. On the one hand, here an enlarged structural space develops for the primary torsional vibration damper at the side of the crankshaft, for example for the bow spring damper, because any potential secondary damper, for example an absorber, is no longer arranged directly in the proximity of the primary damper but distanced from the primary damper, and simultaneously it can be arranged inside the rotor of the electric machine in a space-saving fashion.

This way greater structural space develops for the primary damper at the side of the crankshaft so that it can be designed easier and in an optimal fashion. In torque transmission devices which originally were not equipped with a secondary damper the primary damper, thanks to the invention, can be designed perhaps smaller and more compactly, here, because the secondary damper supports and optimizes the damping of torsional vibrations by the primary damper.

Due to the fact that the secondary damper is arranged according to the invention inside the rotor of the electric machine as well as directly in the output flange of the torque transmission device at the transmission side it requires only minor additional structural space, if any at all. This means that by the perhaps smaller sized primary damper here additional structural space is and/or becomes available, which can be used either for reducing the size of the torque transmission device, particularly shortening it in the axial direction, or for example increasing the size of the electric machine, which in turn results in additional structural space inside the rotor of the electric machine. Last but not least the arrangement of the secondary damper directly in the output flange is advantageous with regards to the multiple use of the component and/or the assembly “output flange”.

According to another particularly preferred embodiment additionally the clutch operation of the disconnect clutch, comprising at least a clutch actuator and a cup spring, is arranged at the side of the crankshaft with regards to the output flange of the torque transmission device at the transmission side, and here preferably positioned entirely inside the rotor of the electric machine.

In other words, this embodiment allows that the clutch actuation for the disconnect clutch of the torque transmission device is no longer arranged (with increased structural space required) at the transmission side with regards to the output flange (thus at least partially outside the torque transmission device) but that the clutch actuation is now arranged with regards to the output flange at the crankshaft side, thus completely inside the torque transmission device, preferably entirely inside the rotor of the electric machine.

This results in a further optimization and/or reduction of the structural space required for the torque transmission device. Due to the fact that here (based on the omission of the clutch operation arranged at the transmission side in reference to the output flange) the output flange of the torque transmission device at the transmission side can additionally be arranged at the end of the torque transmission device at the transmission side, and together with the arrangement according to the invention of the secondary damper in the output flange at the transmission side, inside the rotor of the electric machine additional structural space becomes available to a considerable extent. This also waives the otherwise necessary penetration of the cup spring by the output flange upon the pressure plate of the clutch, the axial and radial structural space required for this purpose, as well as the recesses in the output flange required here.

In this embodiment additionally the clutch operation, particularly the clutch actuator, can be arranged preferably in the radial inner area of the structural space inside the rotor, causing additional structural space to become available in the radial exterior area of the structural space inside the rotor.

The invention is implemented regardless of the design of the disconnect clutch, thus independent of the fact if it represents a one-disk clutch, a multiple-disk clutch, or a wet or dry running clutch, for example.

With the background of the structural space, which can be increased thanks to the invention, particularly inside the rotor of the electric machine, according to another preferred embodiment of the invention it is provided that the disconnect clutch represents a coupling, particularly a multiple-disk clutch. By the arrangement of the secondary damper according to the invention, as explained above, structural space become available, perhaps to a considerable extent, particularly in the radial exterior area inside the rotor of the electric machine, here advantageously a multiple-disk clutch can be arranged. This way it is possible to transmit even strong torque in a relatively small structural space, particularly with a relatively small clutch diameter. The clutch may be embodied as a dry or a wet running clutch, depending on the structural space inside the rotor of the electric machine being embodied as a dry chamber or a wet chamber. The latter also applies for a single disk clutch, which can also be arranged as an alternative to the multiple-disk clutch inside the rotor of the electric machine in a space-saving fashion.

Another preferred embodiment of the invention provides that the housing support of the clutch actuation is connected fixed to the stator housing. This way another reduction of the required structural space is yielded, particularly in reference to torque transmission devices of prior art, in which the clutch operation (in reference to the output flange) is arranged at the torque transmission device at the transmission side, and in which the support of the clutch operation occurs separated from the housing of the torque transmission device and/or the electric machine. Additionally, this way a potential overstressing of the mutual bearing can be avoided between the stator, the rotor, and the input flange and/or driveshaft of the torque transmission device, by connecting the stator housing and the support of the clutch actuator directly and fixed to each other at the crankshaft side.

This advantageous embodiment as well is only possible with the space saving arrangement according to the invention of the secondary damper directly in the output flange at the transmission side, and by the arrangement of the clutch actuation at the crankshaft side of the output flange possible (by the now available structural space inside the rotor), preferably completely inside the rotor of the electric machine.

The invention is initially implemented, regardless of the fact of what type of torsional vibration damper is used for the secondary damper at the transmission side, as long as it can be arranged according to the invention at the output flange of the torque transmission device at the transmission side.

According to a particularly preferred embodiment of the invention the secondary damper comprises a vibration absorber, preferably a centrifugal pendulum damper, switched parallel in reference to the revolving masses of the torque transmission device, particularly the rotor of the electric machine. An absorber embodied as a centrifugal pendulum shows the advantage that it automatically adjusts its damping features to the given speeds, and this way it is effective over a wide range of speeds.

According to another preferred embodiment of the invention the secondary damper comprises a torsional vibration damper switched serially in the force flux through the torque transmission device, for example a torsional vibration damper with coil springs, particularly embodied as bow spring dampers or showing straight pressure springs. In this case the secondary damper forms a joint assembly together with the output flange of the torque transmission device at the transmission side.

Additionally, both types of dampers can be used in a combined fashion by for example arranging them radially distributed over the different diameters of the output flange, for example forming a joint assembly with the output flange.

### BRIEF DESCRIPTION OF THE DRAWINGS

The figures respectively show examples for potential embodiments of torque transmission devices according to the invention. Shown are:

FIG. 1 a torque transmission device according to one embodiment of the invention in a schematic cross-section, and

FIG. 2 an illustration of a torque transmission device similar to FIG. 1 according to another embodiment of the invention.

### DETAILED DESCRIPTION OF THE PREFERRED EMBODIMENTS

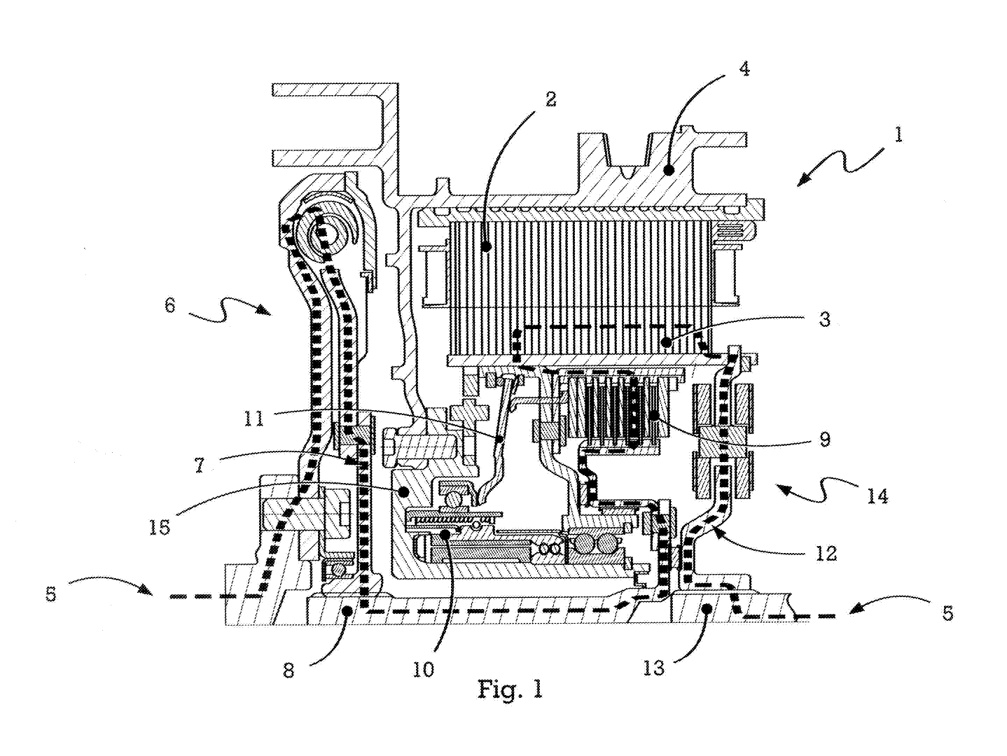

FIG. 1 shows a torque transmission device according to one embodiment of the present invention. Here, at first a stator 2 and a rotor 3 are discernible of the torque transmission device integrated in the electric machine 1. The stator 2 of the electric machine 1 is arranged in a stator housing 4, which in the present case simultaneously forms the housing 4 of the torque transmission device. Further discernible is the force and/or torque flux, which is indicated in the form of a dot-dash line 5 passing through the torque transmission device. The torque is introduced at the side of the crankshaft (at the left in the drawing) via a bow spring damper 6, coming from the crankshaft, via an output flange 7 and a driveshaft 8 into the torque transmission device.

From the driveshaft 8, the torque reaches the disconnect clutch 9 embodied here as a disk clutch, which is actuated via a cup spring 11 and a clutch actuator 10. Instead of the multiple-disk clutch, here for example a single-disk dry clutch can also be arranged as the disconnect clutch 9 in the structural space inside the rotor 3 of the electric machine 1. It is discernible that the clutch actuation comprising the cup spring 11 and the clutch actuator 10 is located in a space-saving fashion in the radially interior area inside the rotor 3 of the electric machine 1. Instead of the cup springs shown, for example a largely stiff pressure cup can be used for the clutch operation as well, while the clutch actuator may be embodied also as a hydraulic clutch actuator instead of an electro-mechanic actuator (as shown).

The disks of the disconnect clutch 9 at the output side are here connected to the rotor 3 of the electric machine 1 and via that part to the output flange 12 of the torque transmission device. The output flange 12 is here connected to the output shaft 13 in a torque-proof fashion, which output shaft introduces the torque into the gearbox (not shown) at the right side of the drawing.

A secondary torsional vibration damper 14 is integrated according to the invention directly in the output flange 12 at the transmission side. The arrangement of the secondary damper 14 directly in the output flange 12 and/or the combination of the secondary damper 14 and the output flange 12 as a single assembly is particularly space-saving in reference to the prior art. Additionally the secondary damper 14 supports and/or releases the primary damper 6 such that the primary damper can be sized perhaps smaller and thus exhibits more space-saving dimensions. This way more structural space is available for other assemblies, particularly for a perhaps longer electric machine 1, or the torque transmission device can be designed shorter in its overall length.

The arrangement of the secondary damper 14 directly in the output flange 12 also benefits the particularly compact positioning of the clutch actuation 10, 11 inside the rotor 3 of the electric machine 1 shown in FIG. 1.

Together with the combination of the secondary damper 14 with the output flange 12, forming a single assembly, here considerable structural simplifications result, and considerable structural space is opened inside the rotor 3 of the electric machine 1. This space is used here to provide a multiple-disk clutch 9 inside the rotor 3 of the electric machine 1, which clutch has a compact design with regards to its diameter, however by its multiple-disk design transmitting strong torque. Additionally it is possible here to connect the housing support 15 of the clutch actuation 10, 11 directly and fixed to the stator housing and/or housing 4 of the torque transmission device, which yields constructive simplifications and which helps to avoid complex and nested positioning of the prior art between the stator housing 4, the rotor 3, and the drive shaft 8, and the potential problems connected thereto with regards to overstressing the bearing and/or transmitting structure-borne noise.

The secondary damper 14 is here embodied as a flywheel pendulum, thus as a vibration absorber, which is switched parallel in reference to the revolving masses of the torque transmission device.

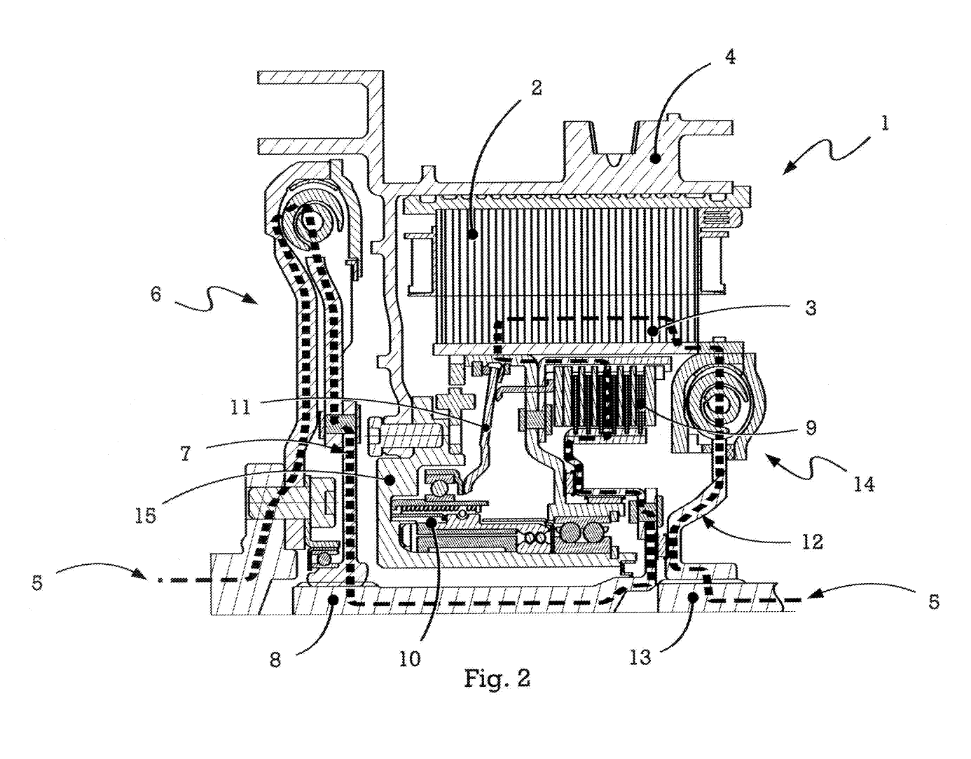

FIG. 2 shows a torque transmission device which is essentially consistent with the torque transmission device according to FIG. 1, particularly with regards to the primary damper 6, the electric machine 1, the disconnect clutch 9 with the clutch actuation 10, 11, and the torque flux 5 through the torque transmission device.

Unlike the torque transmission device according to FIG. 1, the secondary damper 14 in the torque transmission device according to FIG. 2 is not embodied as an absorber parallel in reference to the vibrations, but as a bow spring damper 14, which is directly integrated in the output flange 12 and/or forms a joint assembly together with the output flange 12. This way, the desired support results for the vibration damping of the primary damper 6 by the secondary damper 14, allowing the primary damper to be perhaps designed in a more compact fashion. This in turn allows for the enlargement of the structural space for other components or a more compact design of the entire torque transmission device.

The advantages particularly with regards to additional structural space rendered available, damping of vibrations, and a simpler structural design and arrangement of the clutch actuation 10, 11 are also given in the embodiment according to FIG. 2 as described above with regards to the embodiment according to FIG. 1.

### LIST OF REFERENCE CHARACTERS

1 Electric machine
2 Stator of the electric machine
3 Rotor of the electric machine
4 Housing
5 Force flux (torque flux)
6 Primary vibration damper
7 Drive flange
8 Driveshaft
9 Disconnect clutch
10 Clutch actuator
11 Cup spring
12 Output flange
13 Output shaft
14 Secondary vibration damper
15 Housing support

1. A torque transmission device for arrangement in a drivetrain of a hybrid vehicle with an internal combustion engine, transmission, and electric machine, the torque transmission device including the electric machine arranged in the torque transmission device and comprising a rotor, which is rotational about a central longitudinal axis of the torque transmission device, with the torque transmission device comprising a disconnect clutch with a clutch actuation arrangement for disconnecting the internal combustion engine from the transmission as well as a primary torsional vibration damper at the crankshaft side, a secondary torsional vibration damper arranged radially and axially inside the rotor at a transmission side, which is arranged directly at an output flange of the torque transmission device at the transmission side.

2. The torque transmission device according to claim 1, wherein the clutch actuation arrangement includes a clutch actuator and a cup spring or pressure cup arranged at a crankshaft side in reference to the output flange.

3. The torque transmission device according to claim 2, wherein the clutch actuation arrangement with the clutch actuator and the cup spring is arranged completely inside the rotor of the electric machine.

4. The torque transmission device according to claim 1, wherein the disconnect clutch is embodied as a multiple-disk clutch.

5. The torque transmission device according to claim 1, wherein a housing support of the clutch actuation arrangement is connected fixed to the stator housing.

6. The torque transmission device according to claim 1, wherein the secondary damper comprises a vibration absorber.

7. The torque transmission device according to claim 1, wherein the secondary damper comprises a torsional vibration damper.

8. The torque transmission device according to claim 6, wherein the vibration absorber is a flywheel pendulum.

9. The torque transmission device according to claim 7, wherein the torsional vibration damper is a coil spring-torsional vibration damper.
